(19) United States
(12) Patent Application Publication
(10) Pub. No.: US 2026/0085992 A1
(43) Pub. Date: Mar. 26, 2026

(54) GAS CHROMATOGRAPH VALVE LEAK DETECTOR

(71) Applicant: Rosemount Inc., Shakopee, MN (US)

(72) Inventor: Edward Xiaoyan Zhang, Cypress, TX (US)

(21) Appl. No.: 18/895,674

(22) Filed: Sep. 25, 2024

(51) Int. Cl. G01M 3/28; G01N 30/02; G01N 30/32

(52) U.S. Cl. CPC G01M 3/2876; G01N 30/32; G01N 2030/025; G01N 2030/328

(57) ABSTRACT

A method of testing an analytical valve assembly of a gas chromatograph includes fluidically coupling first and second activation ports of the analytical valve assembly to a manifold. The activation ports are configured to control a first and second valving mechanism which selectively couples and blocks fluidic communication between a first and second pair of analytical ports of the analytical valve assembly in response to an applied pressure. Fewer than all of the analytical ports are fluidically coupled to the manifold. A gas is applied under pressure to the manifold pressurizes the first and second activation ports, and the fewer than all of the analytical ports. A flow of the gas through the manifold is measured and a leak in the analytical valve assembly is detected based upon the measured flow. A leaktest fixture and test system are also provided.

### BACKGROUND

Gas chromatography is a technique used to analyze a mixture of chemical compounds by separating them into individual components due to their differing migration rates through a chromatographic column. This separates the compounds based on differences in boiling points, polarity, molecular size, or other factors. The separated compounds are then analyzed by a suitable detector, such as a flame photometric detector (FPD), that determines the concentration and/or presence of each compound represented in the overall sample. Knowing the concentration or presence of the individual compounds makes it possible to calculate certain physical properties such as BTU or a specific gravity using industry-standard equations.

In operation, a sample is injected into a chromatographic separation column filled with a packing material. Typically, the packing material is referred to as a “stationary phase” as it remains fixed within the column. A supply of inert carrier gas is provided to the column to force the injected sample through the stationary phase. The inert carrier gas is referred to as the “mobile phase” since it transits the column.

As the mobile phase pushes the sample through the column, various forces cause the constituents of the sample to separate. For example, heavier components move more slowly through the column relative to the lighter components. This causes the sample gases to separate into its individual component gases which, in turn, exit the column in a process called elution. The resulting individual component gases are then fed into a detector that responds to some physical trait of the eluting components.

Gas chromatographs require complex valve assemblies which are used to control flow of the various gasses through the components of the chromatograph, as well as allow purging cycles. These valving assemblies are typically controlled by application of a pressurized gas to activation ports of the valve assemblies. This causes movement of a valving mechanism within the valve assembly to open or close connections between various analytical ports of the valve assembly. Over time, the various components of the analytical valve assembly may begin to leak. Such leakage affects operation of the valve assembly and may lead to errors in the analysis of the gas sample.

### SUMMARY

A method of testing an analytical valve assembly of a gas chromatograph including fluidically coupling a first activation port of the analytical valve assembly to a manifold. The first activation port is configured to control a first valving mechanism which selectively couples and blocks fluidic communication between a first pair of analytical ports of the analytical valve assembly in response to an applied pressure. A second activation port of the analytical valve assembly is fluidically coupled to the manifold. The second activation port is configured to control a second valving mechanism which selectively couples and blocks fluidic communication between a second pair of analytical ports of the analytical valve assembly in response to an applied pressure. Fewer than all of the analytical ports are fluidically coupled to the manifold. A gas is applied under pressure to the manifold thereby pressurizing the first activation port, the second activation port and the fewer than all of the analytical ports. Flow of the gas through the manifold is measured and a leak in the analytical valve assembly is detected based upon the measured flow. A leak test fixture and a leak test system for an analytical valve of a gas chromatograph are also provided.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter. The claimed subject matter is not limited to implementations that solve any or all disadvantages noted in the Background.

### BRIEF DESCRIPTION OF THE DRAWINGS

FIG. 1 is a simplified diagram of a gas chromatograph.

FIG. 2 is a simplified block diagram of a prior art leak tester for a gas chromatograph analytical valve.

FIGS. 3A and 3B show a flowchart of steps for testing an analytical gas valve gas chromatograph using the leak tester of FIG. 2.

FIG. 4 is a simplified schematic diagram of a leak tester for a 10-port analytical valve of a gas chromatograph in accordance with one embodiment of the invention.

FIG. 5 is a flowchart showing steps for testing an analytical valve using the leak tester of FIG. 4.

FIGS. 6 and 7 are perspective views of a 10-port analytical valve of a gas chromatograph.

FIG. 8 is a perspective view of a 6-port analytical valve of a gas chromatograph.

FIGS. 9, 10 and 11 are exploded perspective views of a leak test fixture for a 10-port analytical valve of a gas chromatograph.

FIG. 12A is a cut-away perspective view of manifold of the leak test fixture of FIGS. 9-11.

FIG. 12B is a cut-away perspective view of an enlarged portion of FIG. 12A.

FIG. 12C is a cut-away perspective view of an enlarged portion of FIG. 12A.

FIGS. 13A and 13B are exploded views of a leak test fixture for a 6-port analytical valve of the gas chromatograph.

FIGS. 14A, 14B and 14C are cut-away perspective views of the leak test fixtures of FIGS. 13A and 13B.

FIG. 15 is a simplified schematic diagram of a leak test fixture for a 10-port analytical valve of a gas chromatograph.

FIG. 16 is a simplified schematic diagram of a leak test system using a leak test fixture for a 6-port analytical valve of a gas chromatograph.

### DETAILED DESCRIPTION OF ILLUSTRATIVE EMBODIMENTS

Embodiments of the present disclosure are described more fully hereinafter with reference to the accompanying drawings. Elements that are identified using the same or similar reference characters refer to the same or similar elements. Some elements may not be shown in each of the figures in order to simplify the illustrations.

The various embodiments of the present disclosure may be embodied in many different forms, and should not be construed as limited to the specific embodiments set forth herein. Rather, these embodiments are provided so that this disclosure will be thorough and complete, and will fully convey the scope of the present disclosure to those skilled in the art.

As discussed in the Background section, analytical valve assemblies of gas chromatographs can develop leaks over time. These leaks can cause errors in measurement of gas samples. It is important to be able to test the valve assembly to determine if there is any leakage. Typical prior art techniques are complex to implement and require a long period of time to test all of the different component of the analytical valve assembly. With the present invention, the analytical valve assembly is placed in a valve test fixture which has a manifold used to apply a pressurized gas to various ports of the valve assembly. With a pressure applied to the valve assembly through the manifold, a leak can be identified by monitoring a drop in pressure or by monitoring flow of the applied gas through the manifold, which also may result in a change in the applied pressure.

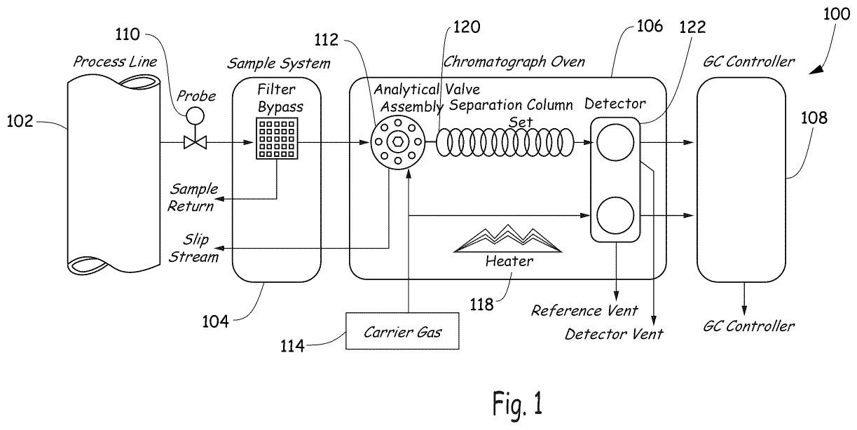

FIG. 1 is a simplified diagram of a gas chromatograph 100 in accordance with one example embodiment of the present invention. Gas chromatograph 100 couples to a process line or piping 102 carrying a process fluid. As used herein, process fluid refers to both liquid and gas phase substances, or their combination. The gas chromatograph 100 includes a sample system 104, a chromatograph oven 106 and a controller 108. The sample system 104 couples to the process line 102 through a probe 110 having a valve therein. Sample system 104 includes a filter which filters undesired components from the sample and provides a sample return. The filtered gas sample is provided to an analytical valve assembly 112 in the chromatograph oven 106. Analytical valve assembly 112 can comprise any number of individual or compound valves. The chromatograph oven includes a heater 118 which is used to heat components within the oven 106 including the analytical valve assembly 112, separation column set 120 and detector 122. Separation column set 120 includes one or more individual separation columns. The analytical valve assembly 112 includes at least one valve and is typically a complex valving device which allows valve(s) to be purged prior to analyzing the sample gas, as well as mix a carrier gas from a carrier gas source 114 with the sample gas. The carrier gas is applied at a first pressure and mixed with the gas samples such that the gas sample is forced through a separation column set 120. Individual component gasses in the sample gas separate as they traverse the column set 120.

The separated individual component gases exit the separation column set 120 based upon their component gas retention time, which is partially a function of the pressure of the carrier gas applied to the separation column set 120. The individual component gasses are detected by detector 122, which can also detect the carrier gas as a reference. The detector 122 provides outputs to the gas chromatograph controller 108 which provides an output to an operator indicating the concentration levels of the various individual component gasses present in the sample gas. The controller 108 is also used to control operation of the gas chromatograph 100 including obtaining the sample gas, controlling the timing of the analytical valve assembly set 112, controlling the pressure of the carrier gas as it is applied to the analytical valve assembly 112 and the separation column set 120, controlling the heater 118 among other things.

As discussed below in more detail, the analytical valve assembly 112 includes activation ports and analytical ports. A pressurized control gas is applied to the activation ports, causing an internal valving mechanism of the valve assembly 112 to move, thereby selectively opening and closing connections between analytical ports. One typical analytical valve assembly is an analytical valve assembly having 12 total ports, 2 activation ports and 10 analytical ports. Another example valve assembly is a 6-port analytical valve assembly having 2 activation ports and 6 analytical ports.

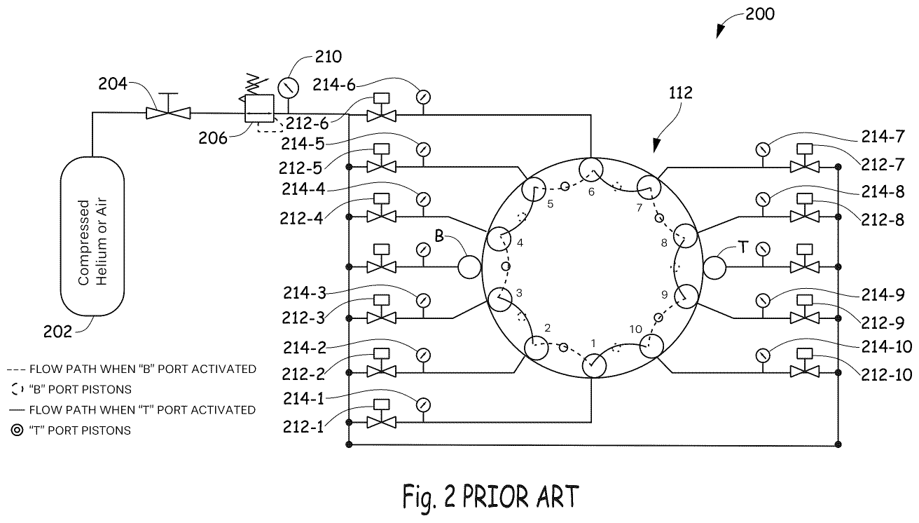

FIG. 2 is a simplified schematic diagram of a typical prior art leak test fixture 200 for, in this instance, an analytical valve assembly 112 configured as a 10-port analytical valve. In FIG. 2, analytical valve 112 includes activation ports B and T and 10 analytical ports labeled 1-10. Activation portions B and T activate an internal valving mechanism, such as a movable piston, in order to selectively open and close passageways between adjacent pairs of analytical ports. The dashed lines between adjacent analytical ports indicate a flow path when the B activation port is pressurized while the T activation port is depressurized. The solid lines between the adjacent pairs of analytical ports indicate a flow path when the T activation port is pressurized while B activation port is depressurized.

The following list of symbols are used in this disclosure and defined as follows:
Δt Time for pressure to stabilize when turning on a solenoid valve momentarily
ΔT Test period to measure pressure decay
m Number of ports of analytical valve
k The k^{th} analytical port of analytical valve. k=1, 2, . . . , m
n Iterations of tests and/or measurements. n=1, 2 . . . m/2
P(i) Initial pressure of shared manifold (for proposed method) after Δt
P(f) Final pressure of shared manifold (for proposed method) after test period ΔT
ΔP=P(i)−P(f). Pressure decay of shared manifold (for new method) after test period ΔT
P(i, k) Initial pressure of analytical port k after Δt
P(f, k) Final pressure of analytical port k after test period ΔT
ΔP(k)=P(i, k)−P(f, k). Pressure decay of port k after test period ΔT
ΔP(2 n−1) Pressure decay of odd ports: ΔP(1), ΔP(3), . . . , ΔP(m−1)
ΔP(2 n) Pressure decay of even ports: ΔP(2), ΔP(4), . . . , ΔP(m)
ΔP(2 n+1) Pressure decay of odd ports: ΔP(1), ΔP(3), . . . , ΔP(m−1), ΔP(1).2 n+1=1, if

$$Δ {P}_{k + 1}^{k} = \vert P ( i , k ) - P ( i , k + 1 ) \vert .$$

P(i, B) Initial pressure of activation port B after Δt
P(f, B) Final pressure of activation port B after test period ΔT

$$Δ P ( B ) = P ( i , B ) - P ( f , B )$$

P(i, T) Initial pressure of activation port T after Δt
P(f, T) Final pressure of activation port T after test period ΔT

$$Δ P ( T ) = P ( i , T ) - P ( f , T )$$

PT Pressure transducer connected to shared manifold (for proposed method)
PT(k) Pressure transducer connected to port k of analytical valve
PT(B) Pressure transducer connected to activation port B of analytical valve
PT(T) Pressure transducer connected to activation port T of analytical valve
q Settled flowrate at set test pressure
Q Setpoint (limit) of leak flowrate
S Solenoid shutoff valve connected to pressure transducer PT (for proposed method)
S(k) Solenoid shutoff valve connected to pressure transducer PT(k)
S(B) Solenoid shutoff valve connected to pressure transducer PT(B)
S(T) Solenoid shutoff valve connected to pressure transducer PT(T)

In FIG. 2, a source of compressed gas 202, such as helium or air, is provided and connected to a main valve 204. A pressure regulator 206 is used to select a desired pressure applied to analytical valve 112, such as 100 psi. The applied pressure is measured using a pressure sensor 210. Each of the 12 ports of the analytical valve 112 couples to the compressed gas source 202 through respective solenoid valves 212-1 . . . 212-10, 212-B, 212-T. Further, individual pressure sensors are arranged to measure the pressure applied to each of these pressure ports and identified as pressure sensors 214-1 . . . 214-10, 214-B, 214-T. In the configuration of FIG. 2, pressurized gas can be applied to the valve 112 and a leak detected if the applied pressure decays over time.

In the configuration of FIG. 2, the testing device is relatively complex and requires numerous valves, controllers, pressure sensors and fittings. This leads to a large internal “dead” volume of unused space in the system. This reduces the sensitivity of the leak test and requires a longer test durations in order to detect a decay in an applied pressure. For example, a typical test cycle time may be 25 minutes for a 10-port analytical valve configuration and 16 minutes for a 6-port analytical valve configuration. In order to increase the speed of the test, the duration of the test performed on the individual ports may be reduced. However, this may lead to inaccuracy and loss of repeatability. Further, this configuration may not be able to detect a condition in which the piston of the internal valving mechanism is stuck and does not move in response to an applied pressure from an activation port.

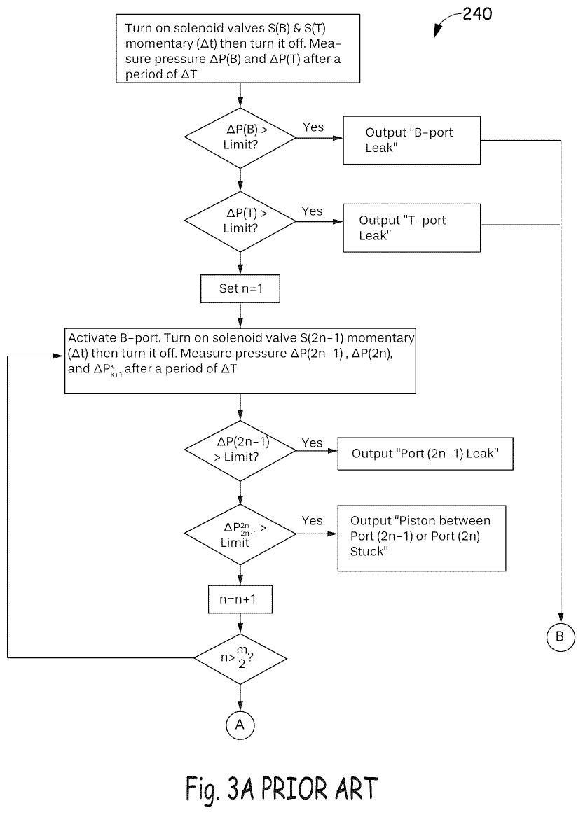

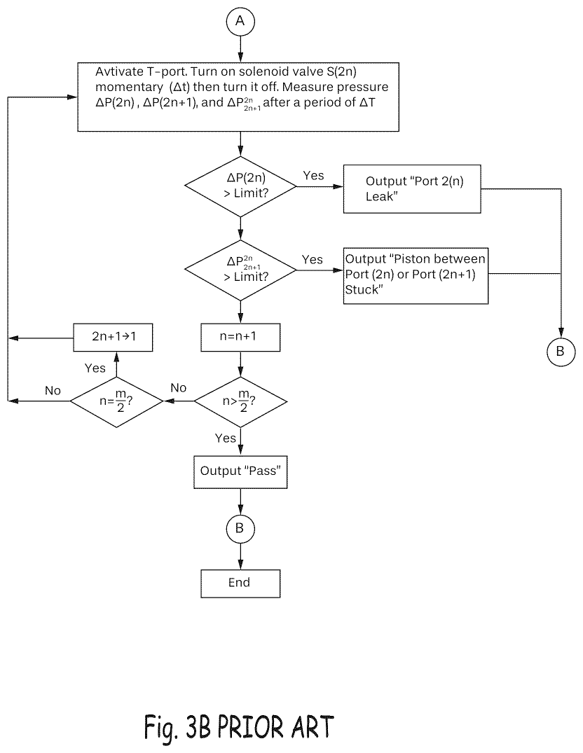

FIGS. 3A and 3B show a flow chart 240 showing the various steps performed by the prior art leak test fixture 200 as illustrated in FIG. 2. As illustrated in FIGS. 3A and 3B, each valve position must be individually tested.

The present invention provides a new configuration and implementation of a leak test for an analytical valve assembly of a gas chromatograph. A new method and test fixture are provided in a configuration in which all of the activation ports of the analytical valve assembly are pressurized simultaneously. This causes the valving mechanism within the analytical valve assembly to block gas flow between pairs of adjacent analytical ports all at the same time. The same pressure source is simultaneously coupled to fewer than all of the analytical ports, for example every other analytical port. A leak in any of the ports will cause the applied pressure to decay. If such a decay is detected, a determination can be made that the analytical valve assembly under test has a leak and should be repaired or replaced.

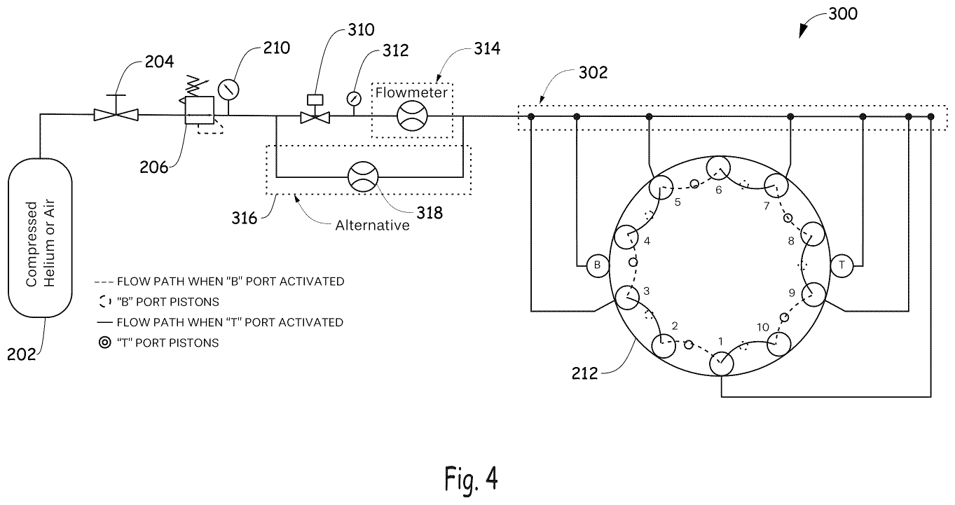

FIG. 4 is a simplified schematic diagram of an analytical valve assembly test fixture 300 in accordance with one embodiment of the present invention. Test fixture 300 includes a shared manifold 302 which connects to the two activation ports B and T of the analytical valve assembly 212, as well as every other analytical port. In this configuration, each of the odd numbered analytical ports are coupled to manifold 302. However, other configurations which couple to fewer than all of the analytical ports can also be implemented.

The manifold 302 is coupled to a source of compressed gas 202 through valve 204 and pressure regulator 206. A pressure sensor 210 is configured to measure the applied pressure. The pressure from the source of compressed gas 202 is applied to the manifold 302 through two alternative techniques. In one configuration, a valve 310 is provided along with a pressure sensor 312. An optional flow meter 314 is provided to measure flow of gas into manifold 302. In an alternative configuration, a passageway 316 is provided through a flow meter 318 which measures flow of the pressurized gas from the compressed gas source 202 into the manifold 302.

When the pressurized gas is applied to manifold 302, the connections between adjacent analytical ports will be blocked due to activation of activation ports B and T. With the pressure applied to odd numbered ports as illustrated in FIG. 4, the pressure decay during time ΔT can be monitored to measure the total leakage from the valve assembly 212, including any leakage through any of the analytical or activation ports. In a specific example, assume that all ports have the same leakage rate. In this configuration, the test fixture 300 is seven times more sensitive than the prior art configuration of FIG. 2, If the test is performed for 60 seconds, it will be forty-two times more sensitive than the prior art configuration. Further, the test duration ΔT can be increased to thereby increase the sensitivity of the leak test.

In one configuration, the pressure is applied to the manifold 302 by activation of valve 310. Valve 310 is then closed. Pressure sensor 312 can then measure any drop in pressure due to leaks in the analytical valve assembly 212. In an alternative configuration, pressure is applied to manifold 302 through passageway 316 and the flow is measured using flow meter 318. Once the manifold 302 is pressurized to the pressure determined by pressure regulator 206, the flow through flow meter 318 should stop. If the flow continues, it can be determined that there is a leak analytical valve assembly 212.

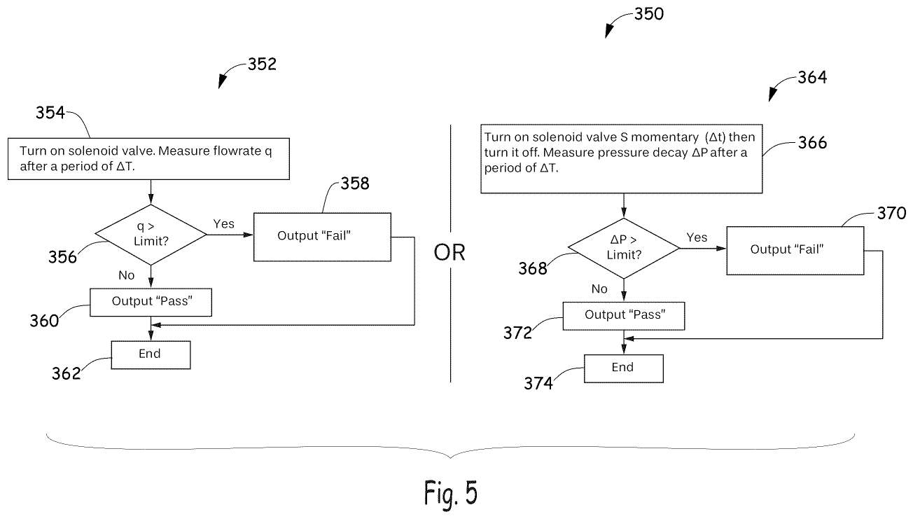

FIG. 5 is a flow chart 350 showing two alternative embodiments 352 and 364 for operation of the test fixture 300 shown in FIG. 4. In the configuration of embodiment 352, the process is started at block 354 when the valve 310 is turned on. Flow rate q is then measured using flow meter 314 after a time period of ΔT. At block 356 the measured flow rate is checked against a desired maximum. If the flow rate is greater than the maximum allowed, control is passed to block 358, and it is determined that the valve 210 has a leak and has failed the test. Alternatively, control is passed to block 360, and it is determined that the valve has passed the leak test successfully. The process then ends at block 362.

In the configuration of the embodiment shown in at 364, at block 366, valve 310 is momentarily turned on for a period of Δt. The pressure is then measured using pressure sensor 312 after the valve 310 has been closed. Any change in pressure ΔP is measured over a time period ΔT. Control is then passed to block 368 where the measured pressure change ΔP is compared against an acceptable limit. If ΔP is greater than the limit, control is passed to block 370 and a fail output is provided, indicating that the valve assembly 212 has a leak. Alternatively, if ΔP is less than the acceptable limit, control is passed to block 372 and a pass output is provided indicating that the valve does not have a leak beyond the acceptable limit. In both cases, the testing is completed at block 374. As illustrated in FIG. 5, the test fixture 300 of the present invention provides a much simplified, and quicker, testing procedure in comparison with the prior art technique of FIGS. 3A and 3B.

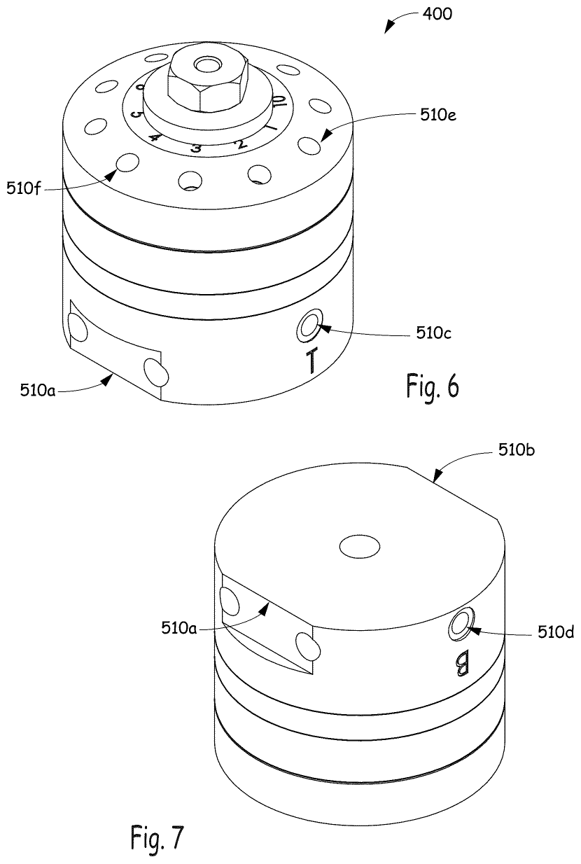

FIG. 6 is a top perspective view and FIG. 7 is a bottom perspective view of one example embodiment of the 10-port analytical valve assembly 400. In these figures, the 10 analytical ports are labeled 1-10 and the activation ports are labeled B and T.

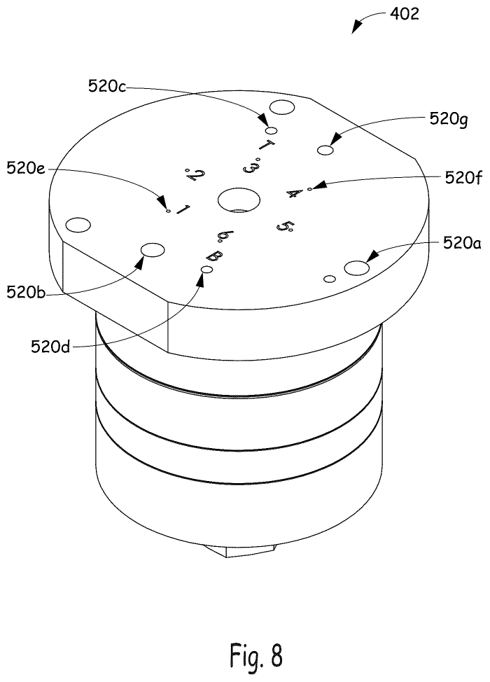

FIG. 8 is a top perspective view of one example configuration of a 6-port analytical valve assembly 402. In FIG. 8, the 6 analytical ports are labeled 1-6 and the activation ports are labeled B and T.

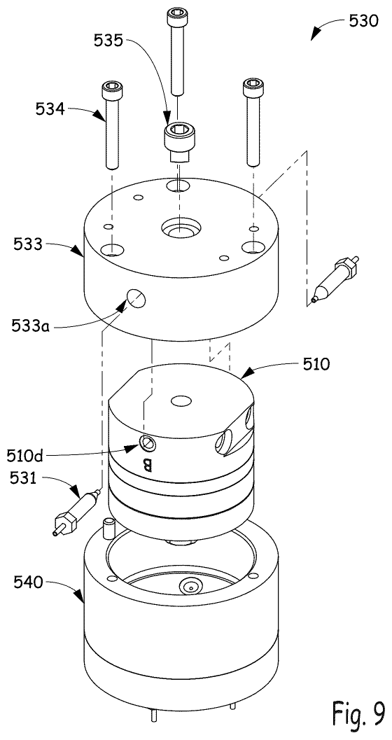

FIGS. 9-15 show one example configuration of a portable leak test fixture 530 for a 10-port valve assemble.

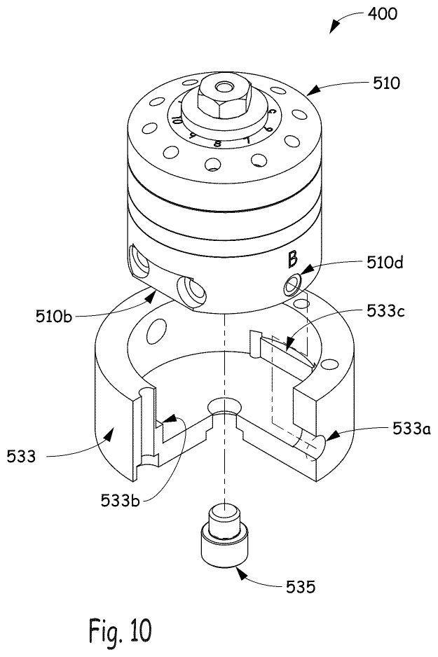

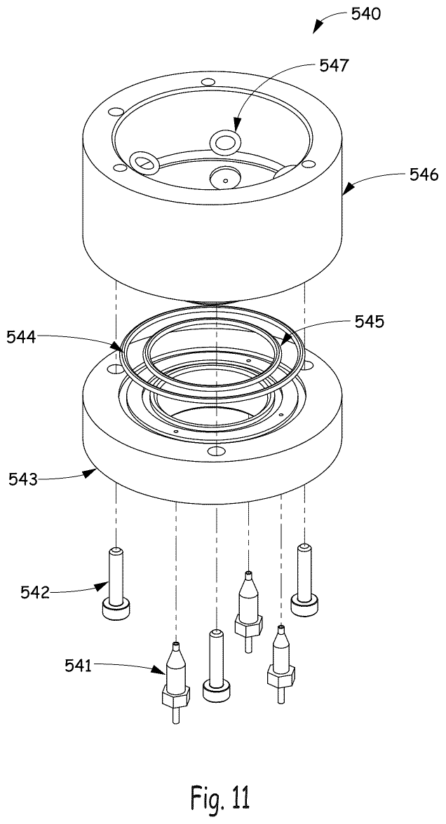

FIG. 9 shows a design of 10-port analytical valve portable leak tester fixture 530. Analytical valve 400 is secured on tester cap 533 by cap screw 535. The orientation of valve 400 on tester cap 533 is set by flat features 510a and 510b of valve 400 and bosses 533b and 533c of tester cap 533 and alignment of B-port 510d of valve 400 and through hole 533a of tester cap 533 as shown in FIG. 10. A manifold assembly 540 of leak tester 530 includes a valve holder 546 and manifold block 543 as shown in FIG. 11.

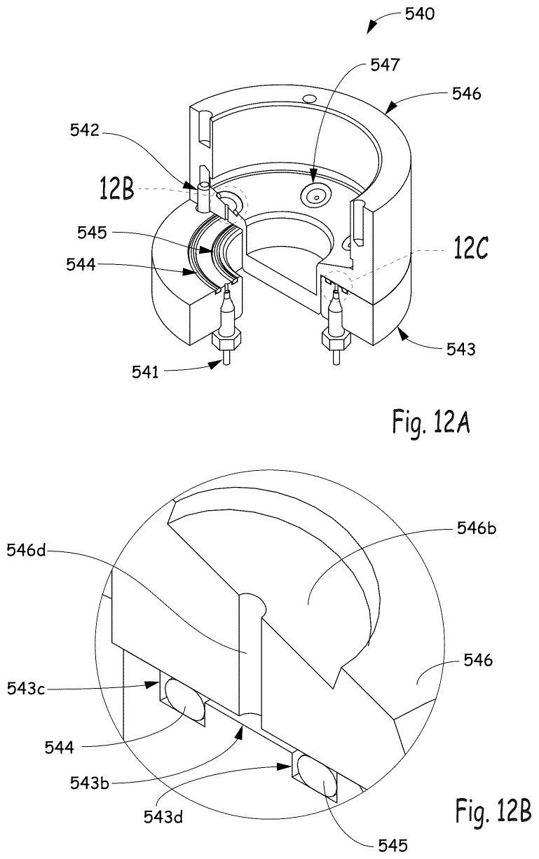

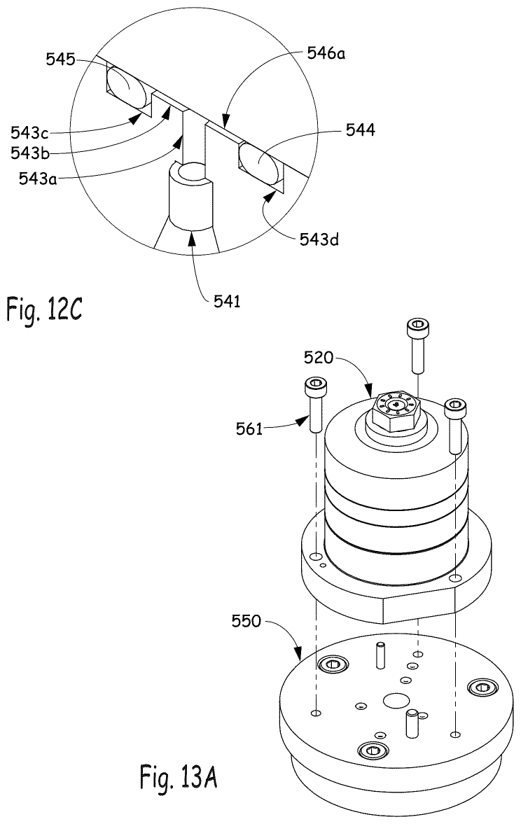

FIGS. 12A-C show the details of the bottom (manifold) assembly 540 of leak tester 530. A very small dead volume of manifold is formed by outer O-ring 544 and its gland 543d, inner O-ring 545 and its gland 543c, top ring surface 543b, and bottom surface 546a of valve holder 546. The dead volume of the manifold connects to the 5 gas pockets 546b on the valve holder 546 by holes 546d and 3 compression fittings 541 by port holes 543a of manifold block 543. O-rings 547 provide a hermetical seal between gas pockets 546b and even ports 510f of valve 510 as shown in FIGS. 6 and 7.

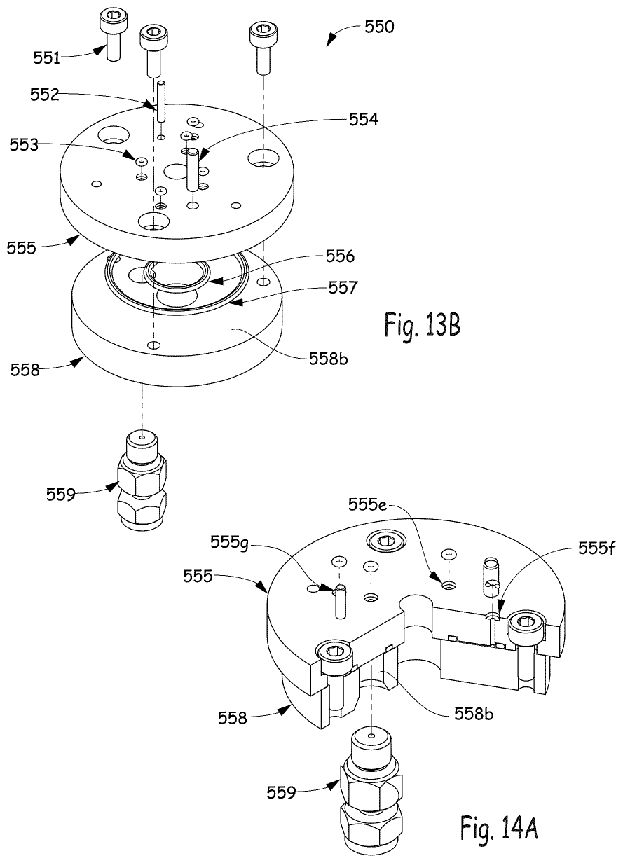

FIGS. 13A-B show a portable leak tester 550 for a 6-port analytical valve 402. This configuration is simpler than the 10-port leak tester because of the O-ring surface seal of valve 402. Valve 402 is secured on the leak tester 550 by 3 cap screws 561. The orientation of valve 520 on the tester 550 is determined by dowel pins 552 and 554.

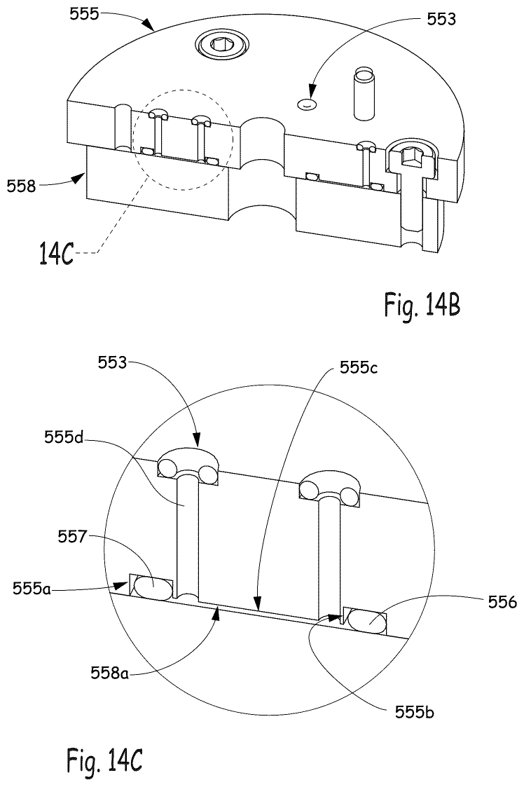

FIGS. 14A-C illustrate the small dead volume provided by the 6-port valve leak tester 550. This dead volume is formed by outer O-ring 557 and its gland 555a, inner O-ring 556 and its gland 555b, top surface 558a of baseplate 558, and ring surface 555c of manifold plate 555. The dead volume links test ports 555e, 555f, and 555g by hole 555d of manifold plate 555 and compressed gas supply port 558b on baseplate 558. Both the 10-port leak tester 530 and the 6-port leak tester 550 provide two design configurations for portable test fixtures having minimal dead volume manifolds used for the leak test system.

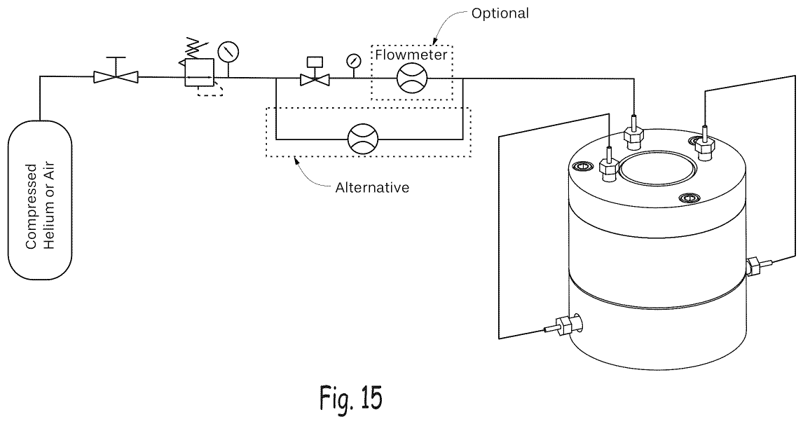

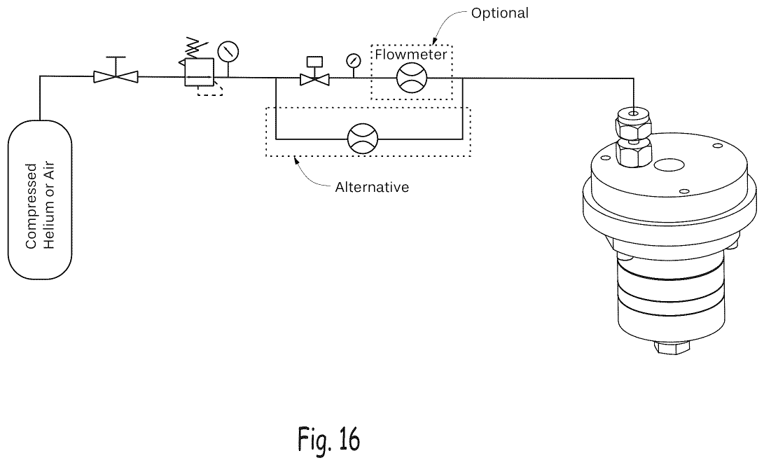

FIG. 15 shows the 10-port analytical valve leak test system and FIG. 16 shows the 6-port analytical valve test system. The pressure decay in a period can be used to measure the total leakage of analytical valves (for example 400 and 402). Since the dead volume of the leak tester is minimized, the pressure transducer can detect a very slow leak in a very short time period. Alternatively, a flow meter can be used to detect any leak in an even shorter time period after the supply pressure in the dead volume of the leak tester stabilizes.

In another example configuration, separate gas supply connections are provided to the analytical ports and the activation ports. As the analytical valve leak tester of the present invention only requires a shutoff valve and a pressure transducer (regulator), a portable analytical leak tester can be provided as a stand-alone device for use in the field.

Although the present invention has been described with reference to preferred embodiments, workers skilled in the art will recognize that changes may be made in form and detail without departing from the spirit and scope of the invention. The test fixture can be fabricated using conventional techniques for through 3D printing. In one configuration, the invention can be used to test analytical valves of gas chromatographs having an even number of ports.

What is claimed is:

1. A method of testing an analytical valve assembly of a gas chromatograph comprising:
fluidically coupling a first activation port of the analytical valve assembly to a manifold, the first activation port configured to control a first valving mechanism which selectively couples and blocks fluidic communication between a first pair of analytical ports of the analytical valve assembly in response to an applied pressure;
fluidically coupling a second activation port of the analytical valve assembly to the manifold, the second activation port configured to control a second valving mechanism which selectively couples and blocks fluidic communication between a second pair of analytical ports of the analytical valve assembly in response to an applied pressure;
fluidically coupling fewer than all of the analytical ports to the manifold;
applying a gas under pressure to the manifold thereby pressurizing the first activation port, the second activation port and the fewer than all of the analytical ports;
measuring a flow the gas through the manifold; and
detecting a leak in the analytical valve assembly based upon the measured flow.

2. The method of claim 1 including shutting off blow of the gas using a shutoff valve.

3. The method of claim 2 wherein the shutoff valve comprises a solenoid valve.

4. The method of claim 2 wherein the shutoff valve comprises a manual valve.

5. The method of claim 1 wherein flow is measured using a flow measure.

6. The method of claim 1 wherein flow is measured using a pressure sensor.

7. The method of claim 1 including a gas regulator.

8. The method of claim 1 including momentarily opening a shutoff valve to stabilize applied pressure, closing the shutoff valve and responsively measuring pressure decay during a period of time.

9. The method of claim 8 wherein the rate of pressure decay is compared to a threshold to indicate a failing valve.

10. The method of claim 1 including opening a shutoff valve and waiting for applied pressure to stabilize, measuring flow rate of the gas and making a decision based upon the measured flow rate with a threshold.

11. A leak test system for testing an analytical valve assembly of a gas chromatograph having at least one activation port and a plurality of analytical ports, the leak test system comprising:
a test fixture having a manifold coupled to ports configured to seal against an activation port of the analytical valve assembly and fewer than all of the analytical ports of the analytical valve assembly, the activation port configured to control a first valving mechanism which selectively couples and blocks fluidic communication between a first pair of analytical ports of the analytical valve assembly in response to an applied pressure;
a gas source of a gas under pressure;
a shutoff valve which couples the gas source to the manifold, wherein when the shutoff valve is open, pressurized gas is applied to the activation port and fewer than all of the analytical ports thereby pressurizing the activation port and the fewer than all of the analytical ports; and
a flow meter arranged to measure flow of gas through the manifold wherein flow of gas through the manifold which is greater than a specified limit is indicative of a leak in the the analytical valve assembly.

12. The leak test system of claim 11 wherein the manifold is configured to fluidically couple to a second activation port of the analytical valve assembly.

13. The leak test system of claim 11 wherein the analytical valve assembly has six analytical ports.

14. The leak test system of claim 11 wherein the analytical valve assembly has 10 analytical ports.

15. The leak test system of claim 11 wherein the flowmeter comprises a pressure sensor arrange to detect a decay of pressure in the manifold.

16. The leak test system of claim 15 wherein the decay of pressure occurs when the shutoff valve is closed.

17. The leak test system of 11 including a gas regulator which couples between the gas source and the manifold.

18. The leak test system of claim 11 wherein the analytical valve assembly mounts within the leak test fixture.

19. The leak test system of claim 12 wherein the shutoff valve is configured to apply pressurized gas to the first and second activation ports and fewer than all of the analytical ports.
